(19) United States
(12) Patent Application Publication
(10) Pub. No.: US 2020/0184358 A1
(43) Pub. Date: Jun. 11, 2020

(54) Video Content Valuation Prediction Using A Prediction Network

(71) Applicant: HULU, LLC, Santa Monica, CA (US)

(72) Inventors: Hui Zhao, Davis, CA (US); Mingyu Lu, Santa Monica, CA (US)

(21) Appl. No.: 16/211,098

(22) Filed: Dec. 5, 2018

(51) Int. Cl. G06N 7/00; G06N 3/06; H04N 21/442; G06F 11/34

(52) U.S. Cl. CPC G06N 7/005; G06F 11/3466; H04N 21/44204; G06N 3/06

(57) ABSTRACT

In some embodiments, a method receives a plurality of inputs for a video for a plurality of times at a prediction network that includes a plurality of cells. The prediction network generates a plurality of predictions of watch behavior of the video for the plurality of inputs at the plurality of cells. The plurality of predictions predicts a performance of the video on a video delivery service for the plurality of times. Actual performance data generated from users viewing the video on the video delivery service is received before a time. A time series residual for at least a portion of the plurality of predictions is generated from the actual performance data and prior predictions. The portion of the predictions after the time using values in the time series residual is adjusted. The adjusted predictions of watch behavior are output for the video.

### BACKGROUND

A video delivery service may want to predict the performance of a video in the future, such as a weekly watch hour percentage for the next five years. The weekly watch hour percentage may predict the percentage of hours the video is watched by users over the total watch hours. Watch hour percentage may defined as y_title/y_all over a time window, where y_title is the total watch hours for a specific video watched by all possible viewers over a time window, and y_all is the total watch hours for all videos watched by all viewers on the video delivery service. It can be weekly, monthly, or yearly and is referred to as percentage hours (PH). The video delivery service may use another metric called percentage cost (PC) to measure the cost of each video. The efficiency of a title is assessed by the ratio PH/PC. The video delivery service has a threshold for the efficiency. If the efficiency is lower than the threshold, the video delivery service may have a set of policies on whether or how to purchase a title for the video.

The prediction has multiple challenges. For example, the video delivery service may want to perform the prediction as soon as possible after the video launches, but the video delivery service wants the prediction to be as accurate as possible. Generally, performing the prediction soon after the video launches does not achieve high accuracy because the video delivery service does not have any information regarding the performance of the video on the video delivery service (e.g., the number of watch hours) to perform the prediction.

If predicting the video's performance is performed upon the initial launch of the video on the video delivery service, the video delivery service may use a linear or non-linear regression prediction or analysis to predict the future performance of the video. The regression analysis models the performance using a function that assumes independence between the inputs to the prediction. However, the video delivery service may have weekly watch behavior that may exhibit a strong sequential correlation. That is, the current week's watch behavior may be correlated to the previous week's watch behavior. However, the regression models will ignore this dependency structure and treat each prediction independently. This may result in a prediction that may not be accurate for the performance of the video on the video delivery service.

### BRIEF DESCRIPTION OF THE DRAWINGS

FIG. 1 depicts a simplified system of a method for predicting video performance according to some embodiments.

FIG. 2 depicts a more detailed example of a prediction network according to some embodiments.

FIG. 3 depicts a more detailed example of a cell according to some embodiments.

FIG. 4 depicts an example of a neuron according to some embodiments.

FIG. 5 shows an example of a prediction according to some embodiments.

FIG. 6 shows an example of the altering of the initial prediction according to some embodiments.

FIG. 7 depicts an example of the residuals that are calculated according to some embodiments.

FIG. 8 depicts a video streaming system in communication with multiple client devices via one or more communication networks according to one embodiment.

FIG. 9 depicts a diagrammatic view of an apparatus for viewing video content and advertisements.

### DETAILED DESCRIPTION

Described herein are techniques for a video prediction system. In the following description, for purposes of explanation, numerous examples and specific details are set forth in order to provide a thorough understanding of some embodiments. Some embodiments as defined by the claims may include some or all of the features in these examples alone or in combination with other features described below and may further include modifications and equivalents of the features and concepts described herein.

Some embodiments use a two-stage prediction process to predict a video's future performance, such as a monthly or weekly watch percentage for the video. The prediction may use external or exogenous information from different sources. The prediction of the performance may use sequential correlation when generating the prediction, such as the weekly watch percentage prediction may be correlated to previous watch percentage prediction.

In stage one of the prediction process, a prediction network receives the current exogenous information as input, but also uses information from a previous prediction (or predictions) as input. The prediction takes into account the sequential dependence that exist to generate the prediction. Then, the prediction network outputs the prediction.

Conventionally, a prediction network that takes into account the previous predictions as input may be configured to output a single prediction. For example, the prediction network may be configured to perform a classification, such as to classify the sentiment of a sentence, where the input is a sequence of words, and the output is the label of positive or negative sentiment. In these examples, multiple inputs may be classified into a single output. However, a video delivery service may require that the prediction network output multiple predictions for different time periods, such as weekly predictions. This requires that the prediction network be a many-to-many network, which receives multiple inputs and outputs multiple outputs. The prediction network generates a sequence of predictions given a sequence of input data.

The prediction may be performed during the relative beginning of offering a video on the video delivery service, such as before or at the launch of the video. For example, the prediction can be generated before statistics of actual watch behavior on the video delivery service are received. After the video is released on the video delivery service, statistics for the actual watch behavior are received. Stage two uses the actual behavior on the video delivery service, such as the watch behavior (e.g., hours of time spent watching the video), to adjust future predictions (e.g., predictions for future time periods in which actual watch behavior has not been received). The adjustment analyzes the difference between the predicted performance and the actual performance and then can adjust the future prediction based on the difference. Given that the difference between the predicted performance and the actual performance changes over time, stage two interpolates the difference over time to alter future predictions at other times.

Using stage two simplifies the prediction network because the prediction network can be designed to predict the performance of the video without using statistics for the actual watch behavior. Also, this allows the video delivery service to generate the predicted performance when the video is launched on the video delivery service and then adjust the predictions at a later time. Further, if the prediction network was configured to re-generate the prediction after generating the initial prediction, the logic of the prediction network would have to be changed to use the actual watch behavior after the initial prediction.

System Overview

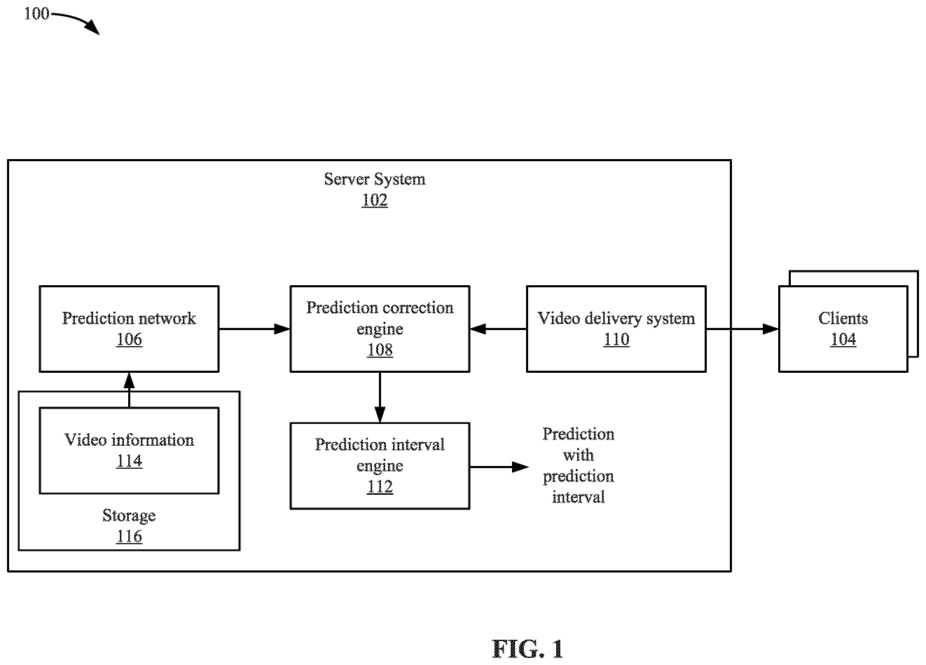

FIG. 1 depicts a simplified system 100 of a method for predicting video performance according to some embodiments. System 100 includes a server system 102 and clients 104.

A video delivery service may deliver videos to users using video delivery system 110. For example, a video delivery system 110 delivers videos to clients 104 that request the videos. Different users may watch videos during a time period. This provides an actual watch behavior that may summarize the viewing of the video during the time period, such as the weekly watch behavior is the percentage of hours the video is watched by users over the total watch hours on the video delivery service. The actual watch behavior may be used later in stage two of the prediction as will be discussed below.

Videos may include different types of videos, such as shows that release episodes, movies, and shorts. The watch behavior of a video may vary on the video delivery service. That is, the watch behavior may not decay linearly. For example, a video may be a show that releases episodes weekly, monthly, or seasonally. This may affect the watch behavior as users may increase the watching of a show when new episodes are released or going to be released. Also, other episodes of shows may see increased viewing when new episodes are released, or a new season starts. This introduces some variability in the watch behavior that is not a constant or regressive decay.

The video delivery service may attempt to predict the performance of videos, which can be used by the video delivery service when providing services to users, such as when forecasting performance of a video or evaluating licensing deals for a video. The prediction may be performed before or when a video is released on the video delivery service. In this case, the video delivery service did not have any actual watch behavior information of users watching the video on the video delivery service. The video delivery service may also make a prediction at other times, such as after the release of the video. However, in some examples, the video delivery service may not use any watch behavior when making the prediction. Starting the prediction as soon as possible may be needed, but the video delivery service also wants the prediction as accurate as possible. If the video delivery service uses actual watch data to generate the prediction with reasonable accuracy, the video delivery service must wait until enough data is received. For this type of prediction, the amount of data may be large, such as two years of data. However, the video delivery service may need the prediction before the video starts streaming on the video delivery service or soon thereafter.

Server system 102 includes a prediction network 106 that can perform a prediction to predict the performance of the video on the video delivery service. For example, prediction network 106 may output watch behavior, such as a weekly or monthly watch behavior percentage. The performance may also be quantified by other factors, such as a number of video views. Prediction network 106 may receive a series of inputs and output multiple predictions for multiple time periods. That is, prediction network 106 does not output a single prediction but outputs a series of predictions for the series of inputs.

Prediction network 106 may make an initial prediction using available exogenous information associated with each video. The exogenous information is information that is different from the actual metric being predicted and may be information that is based on factors outside of the video delivery service or based on information derived from within the video delivery service. The exogenous information may be input into prediction network 106 as exogenous variables, which may be features or explanatory variables that are different from the output variable that is being predicted. For example, the exogenous information may not include the watch behavior if the watch behavior is being predicted. Some examples of exogenous information include the video's launch date in weekly intervals over a period of five years. For example, a show may include multiple launch dates over weekly intervals for episodes. Also, other exogenous information includes the video deal data, content metadata, and temporal data. The video deal data may include whether the content has a contributor license agreement (CLA) license or not. The contact metadata may be metadata associated with the video, such as the number of days from the video's premiere, an indicator as to whether full episodes of a season are available or only partially available, the content provider (e.g., the television (TV) network), the genre of the video, the number of episodes released for the video, and the episode length. The temporal data may include data that is associated with time, such as the number of weeks since the launch date on the video delivery service, the number of weeks since the premiere date of the show, and the month or the week in which the prediction is made. If the prediction is made on the launch date, then the value for the number of weeks since the launch date would be zero. If the prediction is for two weeks in the future, then the value for the number of weeks since the launch date would be two weeks. The use of the above list of features is just an example and other exogenous information may be used.

Prediction network 106 may receive the exogenous information from video information 114 in storage 116. For example, the video delivery service may collect the exogenous information and store it as video information 114 for the various videos offered by the video delivery service. Some embodiments input the exogenous information into multiple inputs of prediction network 106 to predict the performance at multiple outputs. Prediction network 106 may perform the prediction using the correlation between a prior prediction, such as a previous week's watch behavior, to a current prediction being made, such as a current week's watch behavior. This is different from using a linear or non-linear regression scenario, which assumes independence among the input variables of the exogenous information that the prediction network may take as input to make a prediction, because prediction network 106 also receives previous predictions as input. Prediction network 106 then generates the prediction using the two types the exogenous information and the previous prediction for a time period. For example, if weekly predictions are being made, the prediction for the second week may use the exogenous information for the second week and information from the prediction from the first week. The exogenous information for the second week may be different from the first week, such as temporal information for the second week is different from temporal related information for the first week. Further, the prediction for the third week may receive exogenous information for the third week in addition to the prediction from the second week. The prediction from other previous weeks may also be included, such as from the first week. The exogenous information for the third week may also be different from the exogenous information from the first and second weeks, such as the temporal information may change.

Prediction network 106 may have an architecture that is a many-to-many architecture, which means that multiple inputs are received at prediction network 106 and prediction network 106 generates multiple outputs. This allows prediction network 106 to generate a sequence of predictions given a sequence of input data, such as given a sequence of weekly exogenous information. Then, prediction network 106 predicts a sequence of outputs, such as weekly watch percentages. The operation of prediction network 106 will be described in more detail below.

A prediction correction engine 108 receives the predictions from prediction network 106. In some embodiments, the prediction is performed at a certain time, such as at the launch of the video on the video delivery service, and not performed again. As actual performance of the video, such as the actual weekly watch percentage, is received, the video delivery service may be able to evaluate the accuracy of the prediction. For example, prediction correction engine 108 may receive the actual performance of the video (e.g., weekly watch behavior) from video delivery system 110 and then adjust the prediction going forward from a time, such as the current time. The adjusted prediction from prediction correction engine 108 allows the video delivery service to generate a more accurate prediction than the prediction first generated by prediction network 106. The adjusted prediction is generated without having to rerun prediction network 106 again. The correction by prediction correction engine 108 may use less computing resources than re-running the prediction through prediction network 106 using the updated information. Further, the logic of prediction network 106 is simplified by not having to use the actual watch behavior in additional to the exogenous information. Also, because the amount of actual watch behavior needed to train prediction network 106 to output an accurate result is large, the wait to receive that amount of data is not feasible when evaluating the performance of videos on the video delivery service. As will be described in more detail below, prediction correction engine 108 may use the prior performance of the video on the video delivery service to correct the multiple outputs from prediction network 106 in the future.

The two-stage design for performing the prediction involves two stochastic processes, which means that the prediction performed may be random in nature or may have a random probability distribution or pattern that is analyzed statistically but may not be predicted precisely. The predicted values have stochasticity in nature and a single point estimation may not be able to capture a complete spectrum of all possible values. The two stages use model parameters that are learned from a limited quantity of data and are used to generate the prediction. It is possible that given a first set of training data and a second set of training data, the model parameters that are generated may be different from using different sets of data. This results in uncertainty in the prediction.

Prediction interval engine 112 provides a mechanism to estimate the resulting uncertainty in the prediction output. The mechanism can limit the range of values that are predicted. The mechanism estimates the resulting uncertainty in the prediction. For example, the mechanism provides a range of values that is likely to contain the true unknown values (e.g., the unobserved watch percentage).

The output of the prediction with the prediction interval may be used by the video delivery service. For example, the outputs may be used to evaluate content licensing deals, as well as for other forecasting and goal setting purposes. The prediction interval may indicate an upper bound and a lower bound for the values predicted by prediction network 106. For example, if prediction network 106 outputs a watch percentage of 0.1%, the prediction interval may be 0.09% as a lower bound and 0.13% as an upper bound. These indicate values in which there is a high probability the watch percentage falls within.

Prediction Network

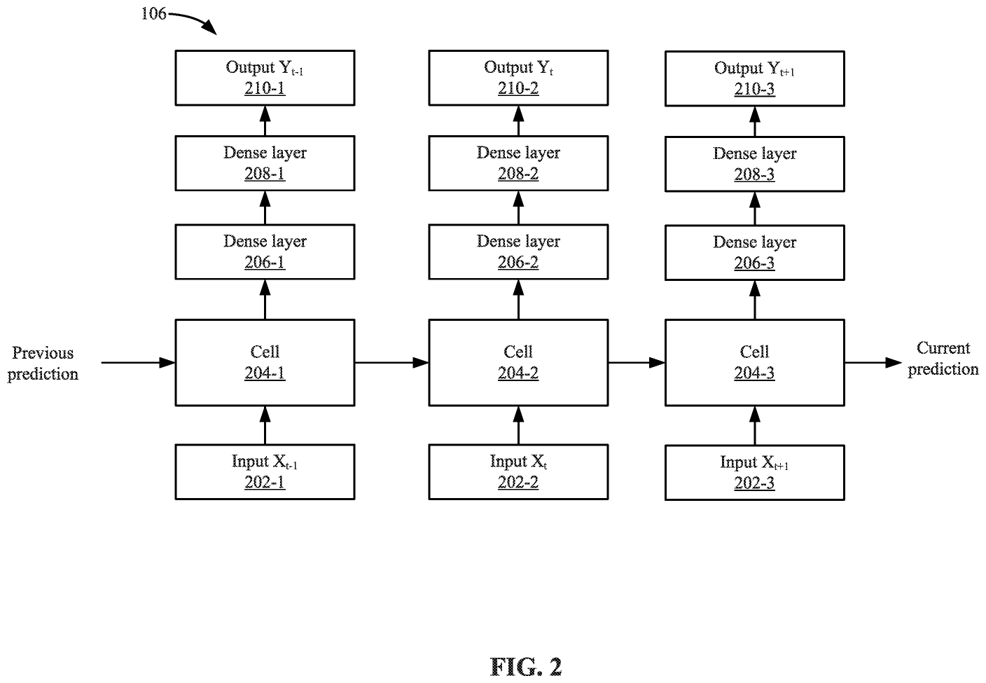

FIG. 2 depicts a more detailed example of prediction network 106 according to some embodiments. Prediction network 106 may include multiple stages that each receive an input 202 and produce an output 210. For example, an input Xₜ₋₁ 202-1 may be input at a time t−1. Input 202-1 may include the exogenous information for the time t−1. A cell 204-1 receives the input Xₜ₋₁ in addition to a prediction from a previous cell. The first cell does not receive a previous prediction since it is the first prediction. Cell 204-1 may receive the exogenous information and the prior prediction into the prediction network, which processes the input and outputs a prediction. The prediction generation inside of cell 204-1 will be described in more detail below.

The output of cell 204-1 is input into two dense layers 206-1 and 208-1 although a different number of dense layers may be used. The dense layers may refine the prediction. Although dense layers are described, other types of layers, such as a stacked LSTM layer, a dropout layer, a batch norm layer, etc., may be used. Dense layer 208-1 generates an output Yₜ₋₁ 210-1, which is the performance prediction for the time t−1. For example, output Yₜ₋₁ may be the weekly watch behavior for a week t−1. A many-to-one configuration does not need dense layers because the many to one prediction network does not have an output from cells for previous time steps. Rather, there is only an output for the very last time step. But a many-to-many configuration needs an output from a cell 204 at each time step. The dense layers provide more modeling flexibility and extendibility to prediction network 106.

An input Xₜ 202-2 includes exogenous information at a time t. A cell 204-2 receives input Xₜ in addition to the prediction output by cell 204-1. Cell 204-2 can then generate a prediction for time t using input Xₜ and prediction from cell 204-1. The output of cell 204-2 is processed through dense layer 206-2 and dense layer 208-2. Then, the output for time t is output Yₜ 210-2, which may be the weekly watch percentage for time t.

Similarly, a cell 204-3 receives input Xₜ₊₁ 202-3 for a time t+1, which may include exogenous information at a time t+1, in addition to the prediction from cell 204-2. The output of cell 204-3 is processed through a dense layer 206-3 and a dense layer 208-3. An output Yₜ₊₁ 210-3 may predict the weekly watch behavior for a time t+1. The above process continues for as many time periods as are being predicted where each time period may be associated with a cell 204. Additionally, each input and output may be associated with a time period being predicted.

Prediction network 106 may be trained to output the prediction. The training data set may be data limited to a number of videos over a time period, such as 240 shows over a two-year time range. To overcome an over-fitting problem from lack of data and also to mitigate numerical stability issues, different techniques, such as drop-out, weight penalization, and batch normalization, may be used.

The above network that uses the prior predictions may be different from typical networks that use prior predictions. For example, a typical problem may be performing natural language processing related tasks that take many inputs, but only output a single output, such as the prediction is for the word that is predicted from input. Prediction network 106 has been altered to generate multiple outputs because prediction network 106 is being used to predict the performance of a video at multiple time periods. Instead of taking a sequence of input data and outputting a single result, prediction network 106 has been altered to generate a sequence of predictions. A layer, called a time distributed layer, is added to make the many-to-many prediction possible.

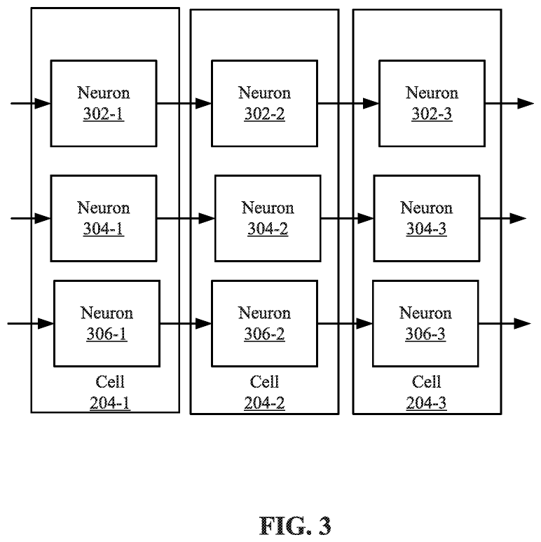

FIG. 3 depicts a more detailed example of a cell 204 according to some embodiments. Cells 204 include a number of neurons 302, 304, and 306. For example, cell 204-1 includes neurons 302-1, 304-1, and 306-1, cell 204-2 includes neurons 302-2, 304-2, and 306-2, and cell 204-3 includes neurons 302-3, 304-3, and 306-3. Each neuron 302, 304, and 306 may receive an input, apply the input to a model, and then generate an output. For example, each neuron may receive an input value, apply a function to the input value, and output a prediction value.

When predicting watch behavior, one aspect of prediction network 106 may become a problem. For example, the number of historical data points used to predict the current value needs to be determined. The number of historical data points may be referred to as the look-back length. For example, the look back length may be the length of the longest input from all the inputs being used. For the video delivery service, the look back length may be how far back historically in watch history, such as the past seven weeks. When only having one output, such as in a natural language prediction, the look-back length may not be a problem because the look-back length may be the longest sentence that is input. For example, if the sentence is shorter than the maximum length, the end of the sentence can be padded, such as by having dummy values at the end of the sentence. However, when predicting watch behavior, the padding of a watch percentage prediction may not be reasonable because determining dummy values for the input data is not intuitive. This means that prediction network 106 cannot use the length of the oldest show on the video delivery service as the look-back length. The length of the oldest show may be the oldest show that was released on the video delivery service. To determine the look-back length, the operation of cell 204 is used.

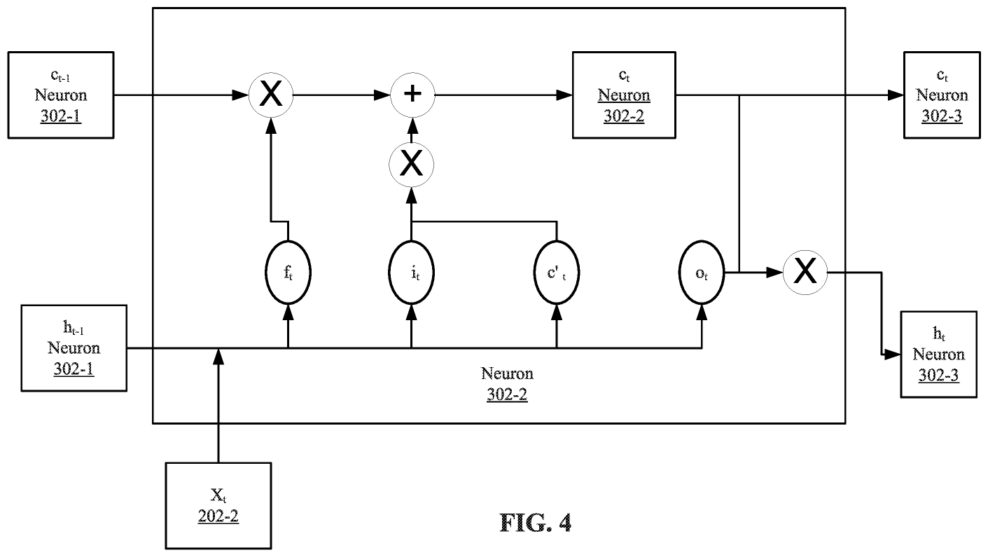

Each cell may be composed of multiple neurons, as described above. FIG. 4 depicts an example of a neuron 302 according to some embodiments. Neuron 302 receives an input of hₜ₋₁ and Cₜ₋₁. The current cell value of Cₜ is a weighted sum of the previous cell value Cₜ₋₁ and the current input value Xₜ. Cell 204 may use the following equations:

fₜ=σ_{g}(W_{f}xₜ+U_{f}hₜ₋₁+b_{f})

iₜ=σ_{g}(Wᵢxₜ+Uᵢhₜ₋₁+bᵢ)

oₜ=σ_{g}(Wₒxₜ+Uₒhₜ₋₁+bₒ)

cₜ=fₜ∘cₜ₋₁+iₜ∘σ_{c}(W_{c}xₜ+U_{c}hₜ₋₁+b_{c})

hₜ=oₜ∘σₕ(cₜ)

The variables W, U, and b are network weights, or also called parameters that will be estimated by training. The variable x is the input data. The variable h is the output from a neuron of a cell 204. The variable c is a cell state. The variable oₜ is a number in the range of 0 and 1, can be considered as a probability called an output probability that is based on the output of the neuron. The variable iₜ is a number in the range of 0 and 1, can be considered as a probability called input probability that is based on the input to the neuron. The variable c′ₜ is the cell state of the current neuron. The variable fₜ is the remember probability, which represents a probability for using historical information and may be a number in the range of 0 and 1, can be considered as a probability called a forget probability that is based on not using historical information.

The weights of neuron 302-2 include the remember probability of variable fₜ and the input probability of iₜ. The remember probability of variable fₜ and the input probability of variable iₜ change over time. The look-back length affects the remember probability and the input probability, which should be considered when selecting a look-back length. In some examples, each neuron may give more weight to the historical data rather than the current input data when predicting a current value. For example, the remember probability is higher than the input probability for all neurons across all timestamps when choosing a look-back length of a value, such as 10 weeks. After analyzing the structure of neuron 302, when a look-back length is longer, neuron 302 may weigh the historical data higher than the current data.

Current value cₜ 302-2 is the weighted sum of the previous cell value cₜ₋₁ from neuron 302-1 and the current input value Xₜ 202-2 combined with the output hₜ₋₁ from a neuron 302-1 of a previous cell 204-1 (with variable fₜ, variable iₜ, and variable c′ₜ applied). The current value is then output to neuron 302-3 in the next cell 204-3. Also, the current value is combined with the output probability and output as output hₜ to neuron 302-3 in the next cell 204-3. The outputs hₜ from each neuron form the output for a cell 204. By not discarding the outputs from neurons, the many to many structure is generated. In a one to many structure, the outputs from cells that are not the last cell are discarded and not used.

Some embodiments compute the ratio of the remember probability versus the input probability and compare the ratios at the last neuron for different look-back lengths. In some examples, a cell with a look-back length of twelve may have consistently higher remember-to-input probability ratios for all neurons than that with look-back length of four. This means the cell tends to remember more from history when look-back length is longer. Some embodiments select a look-back length within a range of five to ten to balance the ratio of using the prior prediction and the current input.

Prediction Output

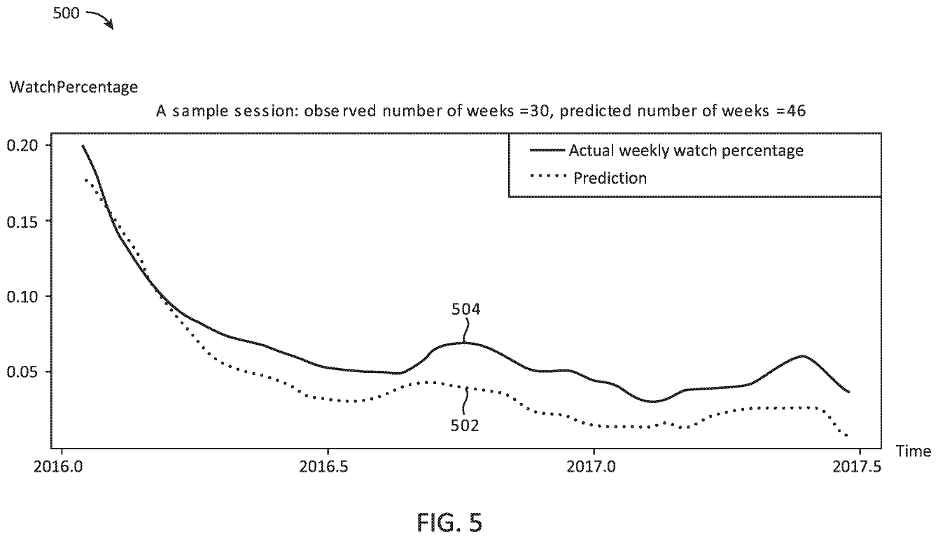

FIG. 5 shows an example graph 500 of a prediction according to some embodiments. For example, the prediction may be for a show that may release multiple episodes over a number of weeks. At 502, the predicted performance, such as the weekly watch hour percentage, is shown. The prediction at 502 represents the initial prediction over the time period. At 504, the actual watch behavior may be shown.

As the video delivery service receives actual watch behavior, the video delivery service may determine the differences between the initial prediction and the actual watch behavior. However, some embodiments do not use the actual watch behavior to generate another prediction using prediction network 106. Rather, a more efficient process to alter the initial prediction is used.

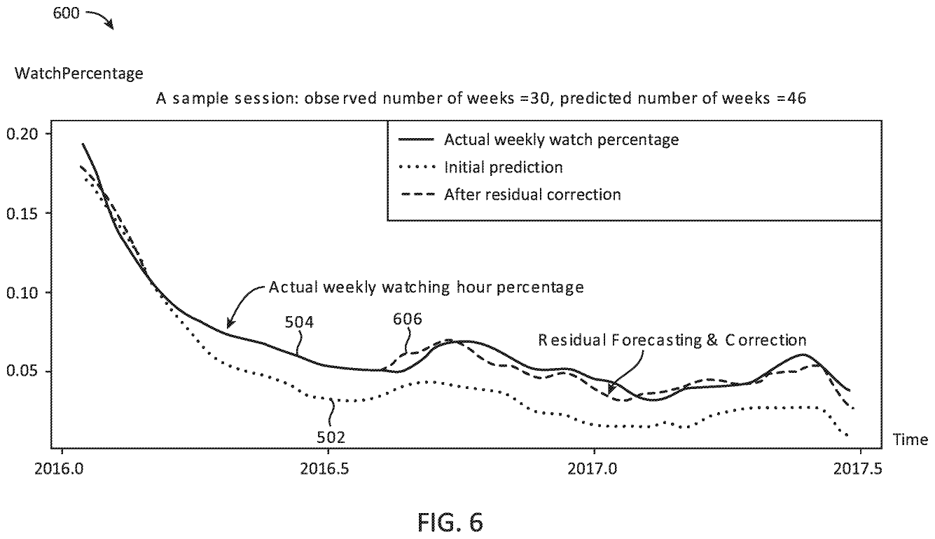

FIG. 6 shows an example graph 600 of the altering of the initial prediction according to some embodiments. At 606, the revision to the initial prediction is shown. The actual watch behavior is known from a point before 608. From point 608, the initial prediction is revised as shown at 606.

To generate the revised prediction, prediction correction engine 108 computes the difference between the actual data and the initial prediction to construct a residual, which represents the difference. Then, prediction correction engine 108 uses a forecasting technique to predict the possible future values of future residuals. The forecasted residuals are then used to correct the initial prediction for the future time period. The residual rₜ can be computed as: rₜ=yₜ^{observed}−yₜ^{pred}, where t in the observed period, where yₜ^{observed} is the actual data and yₜ^{pred} is the predicted data.

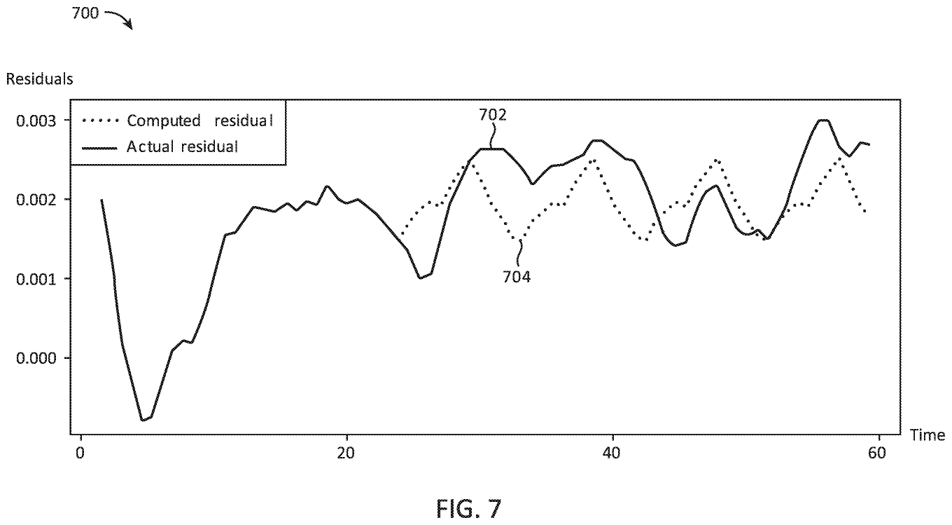

Given the residuals as constructed from the data to the left of point 608, prediction correction engine 108 predicts the possible values of residuals for the time period to the right of point 608. FIG. 7 depicts an example graph 700 of the residuals that are calculated according to some embodiments. A line 702 shows the actual residuals and a line 704 shows the computed residuals that are forecasted.

To generate the future residuals, time series forecasting techniques are used. Given the generated future residuals, the following equation may be used to compute the revised predictions:

yₜ^{corrected}=yₜ^{Pred}+rₜ^{forecasted},where t in the prediction period.

The above equation takes the initial prediction, yₜ^{Pred}, and adds the forecasted residual, rₜ^{forecasted}, during the prediction time period. This results in a generated revised prediction at 606 in FIG. 6.

The use of the time series forecasting is needed due to how the video delivery service uses the prediction. The video delivery service is making decisions on efficiency of a video before having a sufficient amount of watch history to predict the weekly watch behavior. The use of the prediction network after receiving the actual watch history may not be feasible because the video delivery service makes decisions regarding cost before a video is released on the service or soon after the release.

Prediction Interval

Prediction interval engine 112 may generate the prediction interval for the prediction. The two-stage prediction outputs a point estimation, such as a watch percentage prediction for 2019 January 1st week of 0.1%. The watch percentage of 0.1% is called point estimate because it is just a number as opposed to a variable for the watch hour percentage. Due to the reasons stated above, the value of 0.1% may not be trusted. Suppose the true value for 2019 January 1st week is 0.12%, the prediction interval may compute an upper bound and lower bound, for example 0.13% and 0.09% accordingly. Then the true value of 0.12% will fall in the interval of (0.09%, 0.13%). This interval is called a prediction interval. Given that the video delivery service is using the weekly watch behavior to evaluate the efficiency of a video, having a prediction interval is important because the efficiency estimate must be somewhat accurate. By estimating an efficiency interval of percentage hours to percentage cost, the video delivery service can confidently predict efficiency that will fall within a lower bound and upper bound that will most likely be true.

Prediction interval engine 112 generates a two-stage model in the following:

yₜ^{o}=yₜ^{exogenous}+εₜ^{exogenous}+yₜ^{residual}+εₜ^{residual},

where yₜ^{o} is the unobserved true value, and it can be decomposed to two stochastic components of yₜ^{exogenous}+εₜ^{exogenous} and yₜ^{residual}+εₜ^{residual} that represent the initial prediction (from prediction network 106) and residual forecasting process (from prediction correction engine 108), respectively. The terms of εₜ^{exogenous} and εₜ^{residual} are considered as disturbance terms—unobserved random variables that add “noise” to true values of yₜ^{exogenous} and yₜ^{residual} in the stochastics processes. Then, prediction interval engine 112 generates the two-stage prediction for yₜ^{o} as:

ŷₜ=ŷₜ^{exogenous}+ŷₜ^{residual},

where ŷₜ^{exogenous} is the estimate from prediction network 106 and ŷₜ^{residual} is estimated from prediction interval engine 112. Prediction interval engine 112 derives the variance of var(yₜ^{o}−ŷₜ) as:

var(yₜ^{o}−ŷₜ)=var(yₜ^{exogenous}−ŷₜ^{exogenous})+var(εₜ^{exogenous})+var(yₜ^{residual}−ŷₜ^{residual})+var(εₜ^{residual})

Prediction interval engine 112 computes the four variances. For the first variance, the prediction model is ƒ^{Pred}(w; x), which is a nonlinear function with respect to the network weights of w. By the first order Taylor expansion, prediction interval engine 112 generates:

ŷₜ^{exogenous}≈ƒ^{Pred}(w*;x)+g^{T}(w*,x)(ŵ−w*),

where w* is a set of optimal weights, ŵ is the weights learnt from the prediction model training process, and g^{T}(w*,x) is the first order partial derivatives of ƒ^{Pred}(w*;x) with respect to w, evaluated at w*. This is denoted as g^{T} in short. Now prediction interval engine 112 expresses the variance var(yₜ^{exogenous}−ŷₜ^{exogenous}) as:

var(yₜ^{exogenous}−ŷₜ^{exogenous})=var(εₜ^{exogenous})g^{T}(J^{T}J)⁻¹g.

Because prediction network 106 may use regularization during the network training, prediction interval engine 112 determines:

var(yₜ^{exogenous}−ŷₜ^{exogenous})=var(εₜ^{exogenous})g^{T}(J^{T}J+λI)⁻¹(JJ)(J^{T}J+λI)⁻¹g.

where J is the Hessian matrix of ƒ^{Pred}(w*;x) with respect to w, evaluated at w*, λ is the regularization parameter, and var(εₜ^{exogenous}) can be estimated by mean squared errors on the training data, and this is denoted as σ_{Pred}². The variance prediction is then:

var(yₜ^{residual}−ŷₜ^{residual})=F^{T}RₜF,

where F is the design vector in the model used by prediction interval engine 112, and Rₜ is estimated by a filtering algorithm Prediction interval engine 112 estimates the last variance through maximum likelihood methods in the context of model used by prediction interval engine 112, and it is denoted as σ_{residual}².

Prediction interval engine 112 puts all four variances together to get the final variance estimation of:

var(yₜ^{o}−ŷₜ)=σ_{LSTM}²(1+g^{T}(J^{T}J+λI)⁻¹(JJ)(J^{T}J+λI)⁻¹g)+σ_{residual}²+F^{T}RₜF.

The above yields the prediction interval. Given the above formula, prediction interval engine 112 can construct a prediction interval, such as a 90% prediction interval, for predictions over the prediction period, and the prediction interval will cover the unknown true values with a probability of 0.9. The prediction interval bounds the actual watch percentage.

### Conclusion

Accordingly, the above process uses an initial prediction that can predict the performance of a video that requires multiple outputs and a reliance on the previous behavior. Also, the second stage uses a correction to the initial estimate that can use actual watch behavior to adjust the initial prediction. This process more efficiently generates the correction because the initial prediction network does not need to be used to regenerate the prediction. Also, a prediction interval is used to estimate the uncertainty of the output prediction and deliver the range of values.

### System

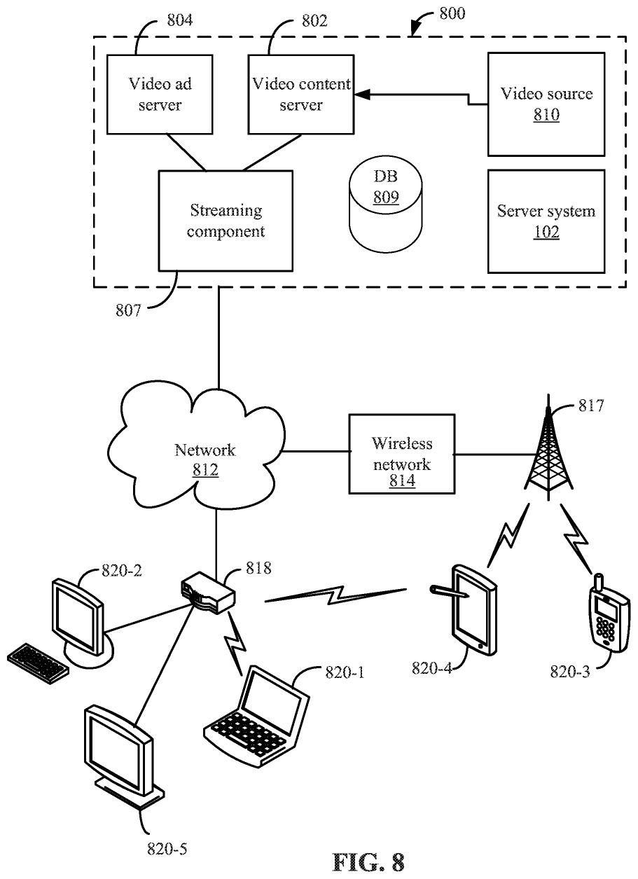

Features and aspects as disclosed herein may be implemented in conjunction with a video streaming system 800 in communication with multiple client devices via one or more communication networks as shown in FIG. 8. Aspects of the video streaming system 800 are described merely to provide an example of an application for enabling distribution and delivery of content prepared according to the present disclosure. It should be appreciated that the present technology is not limited to streaming video applications and may be adapted for other applications and delivery mechanisms.

In one embodiment, a media program provider may include a library of media programs. For example, the media programs may be aggregated and provided through a site (e.g., website), application, or browser. A user can access the media program provider's site or application and request media programs. The user may be limited to requesting only media programs offered by the media program provider.

In system 800, video data may be obtained from one or more sources for example, from a video source 810, for use as input to a video content server 802. The input video data may comprise raw or edited frame-based video data in any suitable digital format, for example, Moving Pictures Experts Group (MPEG)-1, MPEG-2, MPEG-4, VC-1, H.264/Advanced Video Coding (AVC), High Efficiency Video Coding (HEVC), or other format. In an alternative, a video may be provided in a non-digital format and converted to digital format using a scanner and/or transcoder. The input video data may comprise video clips or programs of various types, for example, television episodes, motion pictures, and other content produced as primary content of interest to consumers. The video data may also include audio or only audio may be used.

The video streaming system 800 may include one or more computer servers or modules 802, 804, and/or 807 distributed over one or more computers. Each server 802, 804, 807 may include, or may be operatively coupled to, one or more data stores 809, for example databases, indexes, files, or other data structures. A video content server 802 may access a data store (not shown) of various video segments. The video content server 802 may serve the video segments as directed by a user interface controller communicating with a client device. As used herein, a video segment refers to a definite portion of frame-based video data, such as may be used in a streaming video session to view a television episode, motion picture, recorded live performance, or other video content.

In some embodiments, a video advertising server 804 may access a data store of relatively short videos (e.g., 10 second, 30 second, or 60 second video advertisements) configured as advertising for a particular advertiser or message. The advertising may be provided for an advertiser in exchange for payment of some kind or may comprise a promotional message for the system 800, a public service message, or some other information. The video advertising server 804 may serve the video advertising segments as directed by a user interface controller (not shown).

The video streaming system 800 also may include server system 102.

The video streaming system 800 may further include an integration and streaming component 807 that integrates video content and video advertising into a streaming video segment. For example, streaming component 807 may be a content server or streaming media server. A controller (not shown) may determine the selection or configuration of advertising in the streaming video based on any suitable algorithm or process. The video streaming system 800 may include other modules or units not depicted in FIG. 8, for example, administrative servers, commerce servers, network infrastructure, advertising selection engines, and so forth.

The video streaming system 800 may connect to a data communication network 812. A data communication network 812 may comprise a local area network (LAN), a wide area network (WAN), for example, the Internet, a telephone network, a wireless cellular telecommunications network (WCS) 814, or some combination of these or similar networks.

One or more client devices 820 may be in communication with the video streaming system 800, via the data communication network 812, wireless cellular telecommunications network 814, and/or another network. Such client devices may include, for example, one or more laptop computers 820-1, desktop computers 820-2, “smart” mobile phones 820-3, tablet devices 820-4, network-enabled televisions 820-5, or combinations thereof, via a router 818 for a LAN, via a base station 817 for a wireless cellular telecommunications network 814, or via some other connection. In operation, such client devices 820 may send and receive data or instructions to the system 800, in response to user input received from user input devices or other input. In response, the system 800 may serve video segments and metadata from the data store 809 responsive to selection of media programs to the client devices 820. Client devices 820 may output the video content from the streaming video segment in a media player using a display screen, projector, or other video output device, and receive user input for interacting with the video content.

Distribution of audio-video data may be implemented from streaming component 807 to remote client devices over computer networks, telecommunications networks, and combinations of such networks, using various methods, for example streaming. In streaming, a content server streams audio-video data continuously to a media player component operating at least partly on the client device, which may play the audio-video data concurrently with receiving the streaming data from the server. Although streaming is discussed, other methods of delivery may be used. The media player component may initiate play of the video data immediately after receiving an initial portion of the data from the content provider. Traditional streaming techniques use a single provider delivering a stream of data to a set of end users. High bandwidth and processing power may be required to deliver a single stream to a large audience, and the required bandwidth of the provider may increase as the number of end users increases.

Streaming media can be delivered on-demand or live. Streaming enables immediate playback at any point within the file. End-users may skip through the media file to start playback or change playback to any point in the media file. Hence, the end-user does not need to wait for the file to progressively download. Typically, streaming media is delivered from a few dedicated servers having high bandwidth capabilities via a specialized device that accepts requests for video files, and with information about the format, bandwidth and structure of those files, delivers just the amount of data necessary to play the video, at the rate needed to play it. Streaming media servers may also account for the transmission bandwidth and capabilities of the media player on the destination client. Streaming component 807 may communicate with client device 820 using control messages and data messages to adjust to changing network conditions as the video is played. These control messages can include commands for enabling control functions such as fast forward, fast reverse, pausing, or seeking to a particular part of the file at the client.

Since streaming component 807 transmits video data only as needed and at the rate that is needed, precise control over the number of streams served can be maintained. The viewer will not be able to view high data rate videos over a lower data rate transmission medium. However, streaming media servers (1) provide users random access to the video file, (2) allow monitoring of who is viewing what video programs and how long they are watched (3) use transmission bandwidth more efficiently, since only the amount of data required to support the viewing experience is transmitted, and (4) the video file is not stored in the viewer's computer, but discarded by the media player, thus allowing more control over the content.

Streaming component 807 may use TCP-based protocols, such as HTTP and Real Time Messaging Protocol (RTMP). Streaming component 807 can also deliver live webcasts and can multicast, which allows more than one client to tune into a single stream, thus saving bandwidth. Streaming media players may not rely on buffering the whole video to provide random access to any point in the media program. Instead, this is accomplished through the use of control messages transmitted from the media player to the streaming media server. Other protocols used for streaming are Hypertext Transfer Protocol (HTTP) live streaming (HLS) or Dynamic Adaptive Streaming over HTTP (DASH). The HLS and DASH protocols deliver video over HTTP via a playlist of small segments that are made available in a variety of bitrates typically from one or more content delivery networks (CDNs). This allows a media player to switch both bitrates and content sources on a segment-by-segment basis. The switching helps compensate for network bandwidth variances and also infrastructure failures that may occur during playback of the video.

The delivery of video content by streaming may be accomplished under a variety of models. In one model, the user pays for the viewing of video programs, for example, paying a fee for access to the library of media programs or a portion of restricted media programs, or using a pay-per-view service. In another model widely adopted by broadcast television shortly after its inception, sponsors pay for the presentation of the media program in exchange for the right to present advertisements during or adjacent to the presentation of the program. In some models, advertisements are inserted at predetermined times in a video program, which times may be referred to as “ad slots” or “ad breaks.” With streaming video, the media player may be configured so that the client device cannot play the video without also playing predetermined advertisements during the designated ad slots.

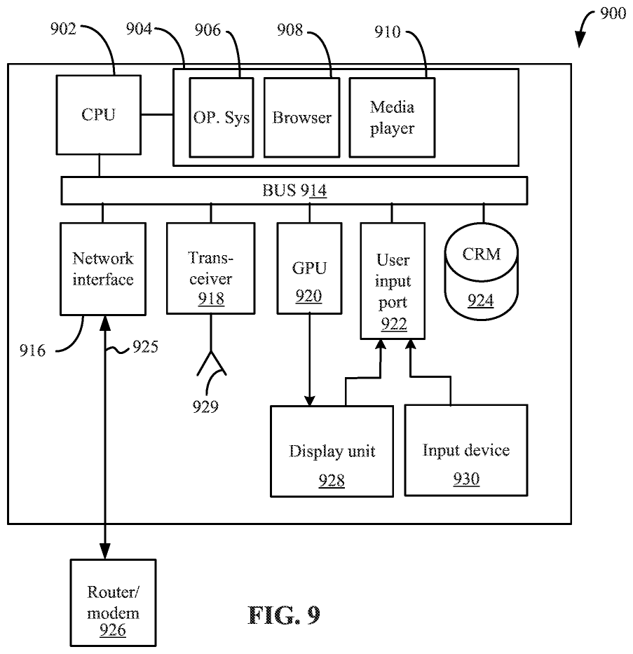

Referring to FIG. 9, a diagrammatic view of an apparatus 900 for viewing video content and advertisements is illustrated. In selected embodiments, the apparatus 900 may include a processor (CPU) 902 operatively coupled to a processor memory 904, which holds binary-coded functional modules for execution by the processor 902. Such functional modules may include an operating system 906 for handling system functions such as input/output and memory access, a browser 908 to display web pages, and media player 910 for playing video. The memory 904 may hold additional modules not shown in FIG. 9, for example modules for performing other operations described elsewhere herein.

A bus 914 or other communication component may support communication of information within the apparatus 900. The processor 902 may be a specialized or dedicated microprocessor configured to perform particular tasks in accordance with the features and aspects disclosed herein by executing machine-readable software code defining the particular tasks. Processor memory 904 (e.g., random access memory (RAM) or other dynamic storage device) may be connected to the bus 914 or directly to the processor 902, and store information and instructions to be executed by a processor 902. The memory 904 may also store temporary variables or other intermediate information during execution of such instructions.

A computer-readable medium in a storage device 924 may be connected to the bus 914 and store static information and instructions for the processor 902; for example, the storage device (CRM) 924 may store the modules 906, 908, 910 and 912 when the apparatus 900 is powered off, from which the modules may be loaded into the processor memory 904 when the apparatus 900 is powered up. The storage device 924 may include a non-transitory computer-readable storage medium holding information, instructions, or some combination thereof, for example instructions that when executed by the processor 902, cause the apparatus 900 to be configured to perform one or more operations of a method as described herein.

A communication interface 916 may also be connected to the bus 914. The communication interface 916 may provide or support two-way data communication between the apparatus 900 and one or more external devices, e.g., the streaming system 800, optionally via a router/modem 926 and a wired or wireless connection. In the alternative, or in addition, the apparatus 900 may include a transceiver 918 connected to an antenna 929, through which the apparatus 900 may communicate wirelessly with a base station for a wireless communication system or with the router/modem 926. In the alternative, the apparatus 900 may communicate with a video streaming system 800 via a local area network, virtual private network, or other network. In another alternative, the apparatus 900 may be incorporated as a module or component of the system 800 and communicate with other components via the bus 914 or by some other modality.

The apparatus 900 may be connected (e.g., via the bus 914 and graphics processing unit 920) to a display unit 928. A display 928 may include any suitable configuration for displaying information to an operator of the apparatus 900. For example, a display 928 may include or utilize a liquid crystal display (LCD), touchscreen LCD (e.g., capacitive display), light emitting diode (LED) display, projector, or other display device to present information to a user of the apparatus 900 in a visual display.

One or more input devices 930 (e.g., an alphanumeric keyboard, microphone, keypad, remote controller, game controller, camera or camera array) may be connected to the bus 914 via a user input port 922 to communicate information and commands to the apparatus 900. In selected embodiments, an input device 930 may provide or support control over the positioning of a cursor. Such a cursor control device, also called a pointing device, may be configured as a mouse, a trackball, a track pad, touch screen, cursor direction keys or other device for receiving or tracking physical movement and translating the movement into electrical signals indicating cursor movement. The cursor control device may be incorporated into the display unit 928, for example using a touch sensitive screen. A cursor control device may communicate direction information and command selections to the processor 902 and control cursor movement on the display 928. A cursor control device may have two or more degrees of freedom, for example allowing the device to specify cursor positions in a plane or three-dimensional space.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured to perform that which is described in some embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations and equivalents may be employed without departing from the scope hereof as defined by the claims.

What is claimed is:

1. A method comprising:
receiving, by a computing device, a plurality of inputs for a video for a plurality of times at a prediction network that includes a plurality of cells;
generating, by the computing device, a plurality of predictions of watch behavior of the video for the plurality of inputs at the plurality of cells, the plurality of predictions predicting a performance of the video on a video delivery service for the plurality of times, wherein cells in the plurality of cells generate a prediction using an input at a time and a prior prediction from a cell at a previous time;
receiving, by the computing device, actual performance data generated from users viewing the video on the video delivery service before a time;
generating, by the computing device, a time series residual for at least a portion of the plurality of predictions from the actual performance data and prior predictions before the time;
adjusting, by the computing device, at least the portion of the predictions after the time using values in the time series residual; and
outputting, by the computing device, the adjusted predictions of watch behavior for the video.

2. The method of claim 1, further comprising:
determining a prediction interval for the plurality of predictions, the prediction interval including a lower bound and an upper bound for the plurality of predictions.

3. The method of claim 1, wherein generating the plurality of predictions comprises:
receiving a first prediction from a first cell at a second cell, the first prediction for a first time in a series;
receiving an input at the second cell, the input based on a second time in the series; and
using the first prediction and the input to generate a second prediction for watch behavior for the second time.

4. The method of claim 3, further comprising:
outputting the prediction for the watch behavior for the second time to a third cell, the third cell configured to generate a third prediction for watch behavior for a third time.

5. The method of claim 1, further comprising:
using a plurality of additional layers to process the plurality of outputs to generate the plurality of predictions.

6. The method of claim 5, wherein the plurality of additional layers comprises dense layers that modify the plurality of predictions from the plurality of cells.

7. The method of claim 1, wherein each cell includes a plurality of neurons that compute a portion of the prediction for each cell.

8. The method of claim 1, wherein:
each cell includes a plurality of neurons, and
outputs from each neuron in a cell are used to determine the prediction for the cell.

9. The method of claim 8, wherein each neuron in a cell is coupled to another neuron in another cell to provide a prediction to the other neuron.

10. The method of claim 8, wherein:
a neuron receives a previous cell state and a previous cell output for a previous neuron in a previous cell, and
the neuron uses the previous cell state and a previous cell output to generate a new cell state and a new cell output.

11. The method of claim 10, wherein:
the neuron weights the previous cell output and combines the weighted previous cell output with the previous cell state to generate the new cell state.

12. The method of claim 10, wherein:
the neuron weights the previous cell output and combines the weighted previous cell output with the new cell state to generate the new cell output.

13. The method of claim 1, wherein the prediction network is not used after received the actual performance data to generate the adjusted predictions.

14. The method of claim 1, wherein:
a look back length of a number of past videos to use is based on a remember probability weight versus an input probability weight of a neuron in a cell, and
the remember probably and the input probability is used to weight an output of a previous neuron.

15. A non-transitory computer-readable storage medium containing instructions, that when executed, control a computer system to be configured for:
receiving a plurality of inputs for a video for a plurality of times at a prediction network that includes a plurality of cells;
generating a plurality of predictions of watch behavior of the video for the plurality of inputs at the plurality of cells, the plurality of predictions predicting a performance of the video on a video delivery service for the plurality of times, wherein cells in the plurality of cells generate a prediction using an input at a time and a prior prediction from a cell at a previous time;
receiving actual performance data generated from users viewing the video on the video delivery service before a time;
generating a time series residual for at least a portion of the plurality of predictions from the actual performance data and prior predictions before the time;
adjusting at least the portion of the predictions after the time using values in the time series residual; and
outputting the adjusted predictions of watch behavior for the video.

16. The non-transitory computer-readable storage medium of claim 15, further configured for:
determining a prediction interval for the plurality of predictions, the prediction interval including a lower bound and an upper bound for the plurality of predictions.

17. The non-transitory computer-readable storage medium of claim 15, wherein generating the plurality of predictions comprises:
receiving a first prediction from a first cell at a second cell, the first prediction for a first time in a series;
receiving an input at the second cell, the input based on a second time in the series; and
using the first prediction and the input to generate a second prediction for watch behavior for the second time.

18. The non-transitory computer-readable storage medium of claim 15, wherein:
each cell includes a plurality of neurons, and
outputs from each neuron in a cell are used to determine the prediction for the cell.

19. The non-transitory computer-readable storage medium of claim 18, wherein:
a neuron receives a previous cell state and a previous cell output for a previous neuron in a previous cell, and
the neuron uses the previous cell state and a previous cell output to generate a new cell state and a new cell output.

20. An apparatus comprising:
one or more computer processors; and
a non-transitory computer-readable storage medium comprising instructions, that when executed, control the one or more computer processors to be configured for:
receiving a plurality of inputs for a video for a plurality of times at a prediction network that includes a plurality of cells;
generating a plurality of predictions of watch behavior of the video for the plurality of inputs at the plurality of cells, the plurality of predictions predicting a performance of the video on a video delivery service for the plurality of times, wherein cells in the plurality of cells generate a prediction using an input at a time and a prior prediction from a cell at a previous time;
receiving actual performance data generated from users viewing the video on the video delivery service before a time;
generating a time series residual for at least a portion of the plurality of predictions from the actual performance data and prior predictions before the time;
adjusting at least the portion of the predictions after the time using values in the time series residual; and
outputting the adjusted predictions of watch behavior for the video.
